(19) United States
(12) Patent Application Publication
(10) Pub. No.: US 2014/0055380 A1
(43) Pub. Date: Feb. 27, 2014

(54) TOUCH PANEL

(71) Applicant: SAMSUNG ELECTRO-MECHANICS CO., LTD., Gyunggi-do (KR)

(72) Inventors: Seung Heon Han, Gyunggi-do (KR); Hee Soo Kim, Gyunggi-do (KR); Jung Eun Noh, Gyunggi-do (KR)

(73) Assignee: SAMSUNG ELECTRO-MECHANICS CO., LTD., Gyunggi-do (KR)

(21) Appl. No.: 13/686,796

(22) Filed: Nov. 27, 2012

(30) Foreign Application Priority Data
Aug. 23, 2012 (KR) 10-2012-0092599

(51) Int. Cl. G06F 3/041

(52) U.S. Cl. CPC G06F 3/041
USPC 345/173

(57) ABSTRACT

Disclosed herein is a touch panel including an electrode pattern formed by forming imaginary lattices configured of same polygons as each other, randomly generating predetermined points in the polygons, and connecting the predetermined points and vertexes of the polygons to each other. The electrode pattern is irregularly formed, thereby making it possible to prevent a Moire phenomenon and improve visibility.

### CROSS REFERENCE TO RELATED APPLICATION

This application claims the benefit of Korean Patent Application No. 10-2012-0092599, filed on Aug. 23, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

However, according to rapid advancement of an information-oriented society, since use of computers has increasingly expanded, it is difficult to efficiently operate a product using only the keyboard and the mouse currently serving as the input device. Therefore, necessity for a device, which is simple, has a less malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, or a cathode ray tube (CRT) to thereby be used to allow a user to select desired information while viewing the image display device.

The touch panel is classified into a resistive type, a capacitive type, an electromagnetic type, a surface acoustic wave (SAW) type, and an infrared type. These various types of touch panels are adapted for an electronic product in consideration of a signal amplification problem, a resolution difference, the degree of difficulty of designing and processing technologies, an optical characteristic, an electrical characteristic, a mechanical characteristic, resistance to an environment, an input characteristic, durability, and economical efficiency. Currently, the resistive type touch panel and the capacitive type touch panel have been prominently used in a wide range of fields.

Meanwhile, research into a technology of forming an electrode pattern by using metal in the touch panel has been actively conducted as described in patent documents such as a prior art document below. As described above, when the electrode pattern is made of the metal, electric conductivity is excellent and demand and supply is smooth. However, in the case in which the electrode pattern is made of the metal, the electrode pattern should be formed in a mesh structure in a micrometer (μm) unit in order to prevent users from recognizing the electrode pattern. However, when the electrode pattern of the touch panel is formed in the mesh structure having regular and constant intervals, period characteristics of the electrode pattern of the touch panel and a black matrix pattern of a color filter included in an image display device (a liquid crystal display (LCD), or the like) are overlapped with each other, such that a Moire phenomenon is generated, thereby deteriorating visibility.

### PRIOR ART DOCUMENT

### Patent Document

(Patent Document 1) KR2010-0091497 A

### SUMMARY OF THE INVENTION

The present invention has been made in an effort to provide a touch panel capable of preventing a Moire phenomenon and improving visibility by forming imaginary lattices configured of the same polygons as each other, randomly generating predetermined points in the polygons, and connecting the predetermined points and vertexes of the polygons to each other.

According to a preferred embodiment of the present invention, there is provided a touch panel including an electrode pattern formed by forming imaginary lattices configured of same polygons as each other, randomly generating predetermined points in the polygons, and connecting the predetermined points and vertexes of the polygons to each other.

The polygon may be a triangle, a quadrangle, or a hexagon.

The predetermined point may be generated at only one polygon of which two polygons are adjacent to each other.

The touch panel may further include a transparent substrate having the electrode pattern formed thereon.

The electrode pattern may be made of copper (Cu), aluminum (Al), gold (Au), silver (Ag), titanium (Ti), palladium (Pd), chromium (Cr), or a combination thereof.

The electrode pattern may be made of metal silver formed by exposing/developing a silver salt emulsion layer.

According to another preferred embodiment of the present invention, there is provided a touch panel including: a first electrode pattern formed by forming imaginary lattices configured of first polygons which are the same as each other, randomly generating first predetermined points in the first polygons, and connecting the first predetermined points and vertexes of the first polygons to each other; and a second electrode pattern formed by forming imaginary lattices configured of second polygons which are the same as each other, randomly generating second predetermined points in the second polygons, and connecting the second predetermined points and vertexes of the second polygons to each other.

The first polygon may be a triangle, a quadrangle, or a hexagon, and the second polygon may be a triangle, a quadrangle, or a hexagon.

The first predetermined point may be generated at only one polygon of which two polygons are adjacent to each other.

The second predetermined point may be generated at only one polygon of which two polygons are adjacent to each other.

The touch panel may further include a transparent substrate having the first electrode pattern formed on one surface thereof and the second electrode pattern formed on the other surface thereof.

The touch panel may further include a first transparent substrate having the first electrode pattern formed thereon and a second transparent substrate having the second electrode pattern formed thereon.

The first electrode pattern or the second electrode pattern may be made of copper (Cu), aluminum (Al), gold (Au), silver (Ag), titanium (Ti), palladium (Pd), chromium (Cr), or a combination thereof.

The first electrode pattern or the second electrode pattern may be made of metal silver formed by exposing/developing a silver salt emulsion layer.

The first polygon and the second polygon may be the same as each other.

The first polygon may be different from the second polygon.

### BRIEF DESCRIPTION OF THE DRAWINGS

The above and other objects, features and advantages of the present invention will be more clearly understood from the following detailed description taken in conjunction with the accompanying drawings, in which:

FIGS. 1 to 3 are plan views showing a process of forming an electrode pattern of a touch panel according to a preferred embodiment of the present invention;

FIGS. 4 to 6 are plan views showing a modified example of the touch panel according to the preferred embodiment of the present invention;

FIG. 7 is a cross-sectional view of a touch panel according to the preferred embodiment of the present invention;

FIGS. 8 to 10 are plan views showing a process of forming an electrode pattern of a touch panel according to another preferred embodiment of the present invention;

FIGS. 11 and 12 are plan views showing a modified example of the touch panel according to another preferred embodiment of the present invention; and

FIGS. 13 and 14 are cross-sectional views of the touch panel according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

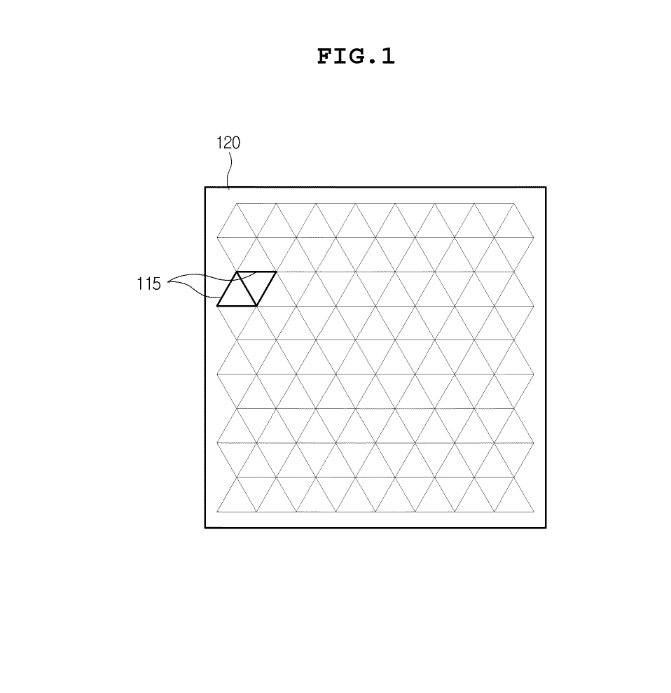

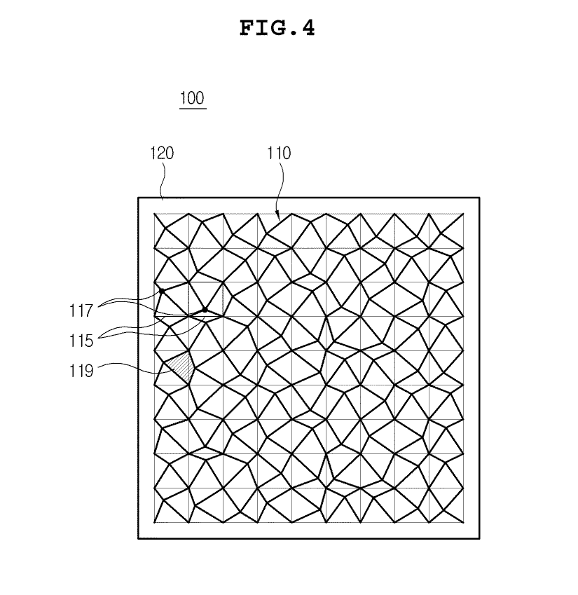

FIGS. 1 to 3 are plan views showing a process of forming an electrode pattern of a touch panel according to a preferred embodiment of the present invention; FIGS. 4 to 6 are plan views showing a modified example of the touch panel according to the preferred embodiment of the present invention; and FIG. 7 is a cross-sectional view of a touch panel according to the preferred embodiment of the present invention.

As shown in FIGS. 1 to 3, the touch panel 100 according to the present embodiment includes an electrode pattern 110 formed by forming imaginary lattices configured of the same polygons 115 as each other, randomly generating predetermined points 117 in the polygons 115, and connecting the predetermined points 117 and vertexes of the polygons 115 to each other.

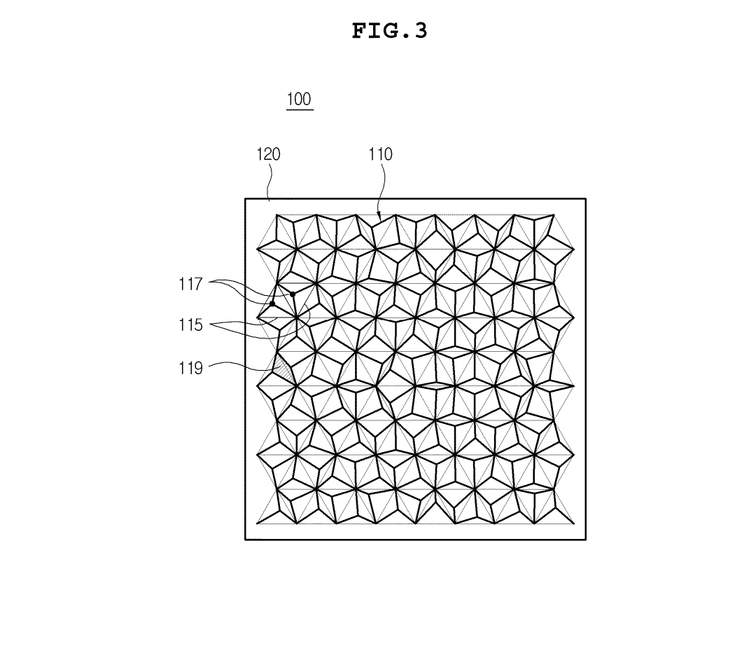

The electrode pattern (110 in FIG. 3) serves to allow a user to recognize touch coordinates in a controller by generating a signal at the time of touching the touch panel. Here, the electrode pattern 110 may be formed in a fine pattern using copper (Cu), aluminum (Al), gold (Au), silver (Ag), titanium (Ti), palladium (Pd), chromium (Cr), or a combination thereof. In addition, the electrode pattern 110 may be formed by a plating process or a depositing process using a sputter. Meanwhile, in the case in which the electrode pattern 110 is made of copper (Cu), a surface of the electrode pattern 110 may be black-oxide treated. Here, the black-oxide treatment indicates treatment in which Cu₂O or CuO is precipitated by oxidizing the surface of the electrode pattern 110, wherein the Cu₂O is brown and is thus referred to as a brown oxide and the CuO is black and is thus referred to as a black oxide. As described above, the surface of the electrode pattern 110 is black-oxide treated to prevent light from being reflected, thereby making it possible to improve visibility of the touch panel 100. Further, the electrode pattern 110 may also be made of metal silver formed by exposing and developing a silver salt emulsion layer, in addition to the above-mentioned metal.

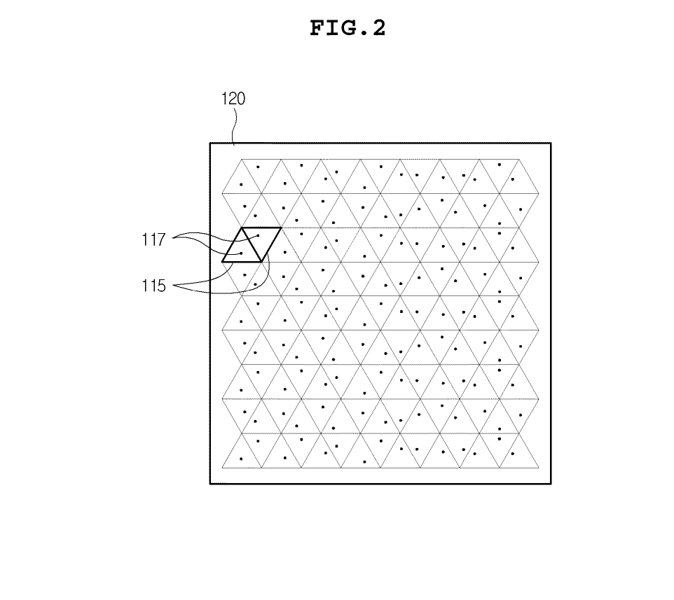

In addition, the electrode pattern 110 is pattered according to a regular rule. Firstly, as shown in FIG. 1, the imaginary lattices configured of the polygons 115 are formed. Here, the polygons 115 configuring the imaginary lattices are the same as each other. The polygon 115 configuring the imaginary lattice, which is a basis for generating the predetermined point 117, randomly generate the predetermined point 117 in the polygons 115, as shown in FIG. 2. That is, the predetermined point 117 may be generated anywhere in the polygons 115. After generating the predetermined point 117, as shown in FIG. 3, the predetermined point 117 is connected to a vertex of the polygons 115 configuring the imaginary lattice to thereby form the electrode pattern 110. Since the predetermined point 117 is randomly formed in the polygon 115, the electrode pattern 110 formed by connecting the predetermined point 117 and the vertex of the polygon 115 to each other are also irregularly formed. In particular, each segment of the unit patterns 119 configuring the electrode patterns 110 has a random angle and a length of the segment is short. As described above, since the angle of each segment of the unit patterns 119 configuring the electrode patterns 110 is random, and the length of the segment is short, period characteristics between the electrode pattern 110 and a black matrix pattern of a color filter provided in a display are not overlapped with each other, thereby making it possible to prevent a Moire phenomenon and improve visibility. In addition, the predetermined points 117 are randomly formed in the polygons 115 to irregularly form the electrode pattern 110; however, a position at which the predetermined point 117 is generated is limited in the polygons 115 configuring the imaginary lattice. Therefore, electrical characteristics and optical characteristics of the electrode pattern 110 are average, and an aperture ratio of the electrode pattern 110 is also average. In addition, in the case of continuously connecting the unit pattern 119 of the electrode pattern 110, the electrode pattern 110 having a large size may be formed without discontinuity of the electrical characteristics and the optical characteristics.

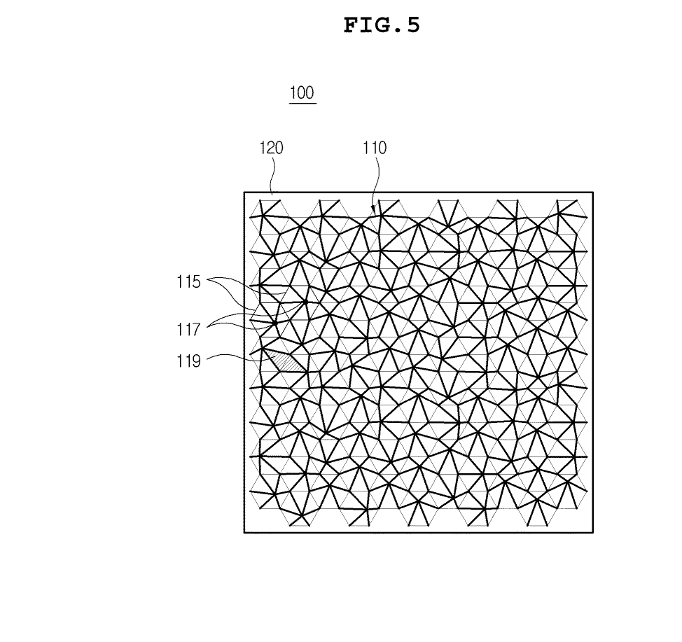

Meanwhile, the polygons 115 configuring the imaginary lattices may be a triangle (FIG. 3), a quadrangle (FIG. 4), or a hexagon (FIG. 5).

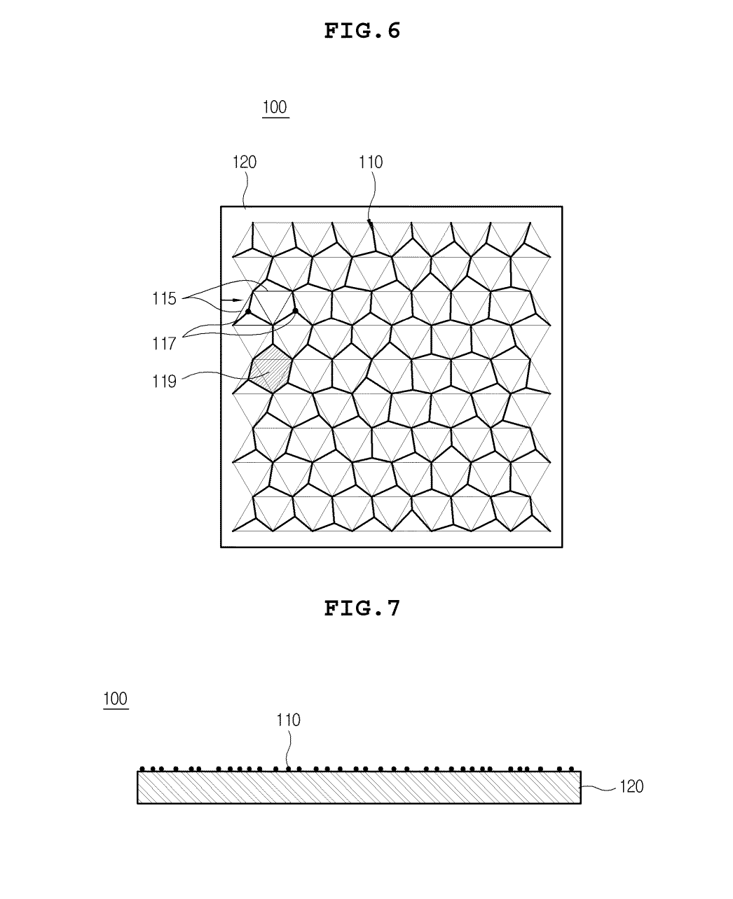

In addition, as shown in FIG. 6, the predetermined points 117 are not necessarily formed in all polygons 115 configuring the imaginary lattice, but may be formed at only one polygon 115 of which two polygons are adjacent to each other. That is, the polygon 115 having the predetermined point 117 formed therein and the polygon 115 not having the predetermined point 117 formed therein may be alternately present toward one direction (see arrow direction) according to the imaginary lattice. Here, the unit patterns 119 configuring the electrode patterns 110 are the same as combining a plurality of unit patterns 119 at the time of forming the predetermined point 117 in all polygons 115. In addition, since the number of vertexes of the unit patterns 119 is increased as compared to the case of forming the predetermined points 117 in all polygons 115, each segment of the unit patterns 119 may have a more random angle. Therefore, the touch panel 100 may effectively prevent the Moire phenomenon and improve visibility.

In addition, as shown in FIG. 7, the touch panel 100 according to the present embodiment may include a transparent substrate 120 having the electrode pattern 110 formed thereon. Here, the transparent substrate 120 provides an area at which the electrode pattern 110 will be formed. In this case, the transparent substrate 120 should be provided with support force capable of supporting the electrode pattern 110 and transparency through which a user can recognize an image provided from a display. In consideration of the support force and the transparency described above, the transparent substrate 120 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, tempered glass, or the like, but is not necessarily limited thereto.

Here, in order to activate one surface of the transparent substrate 120, a high frequency treatment or a primer treatment may be performed. As described above, one surface of the transparent substrate 120 is activated, thereby making it possible to improve adhesion between the transparent substrate 120 and the electrode pattern 110.

In addition, an electrode wiring transmitting/receiving an electrical signal from the electrode pattern 110 may be formed at an edge of the electrode pattern 110 Here, the electrode wiring may be integrally formed with the electrode pattern 110 to simplify a manufacturing process and reduce a lead time. In addition, since the electrode wiring and the electrode pattern 110 are integrally formed, a bonding process of the electrode wiring and the electrode pattern 110 may be omitted. Therefore, it is possible to previously prevent steps or bonding defects between the electrode wiring and the electrode pattern 110.

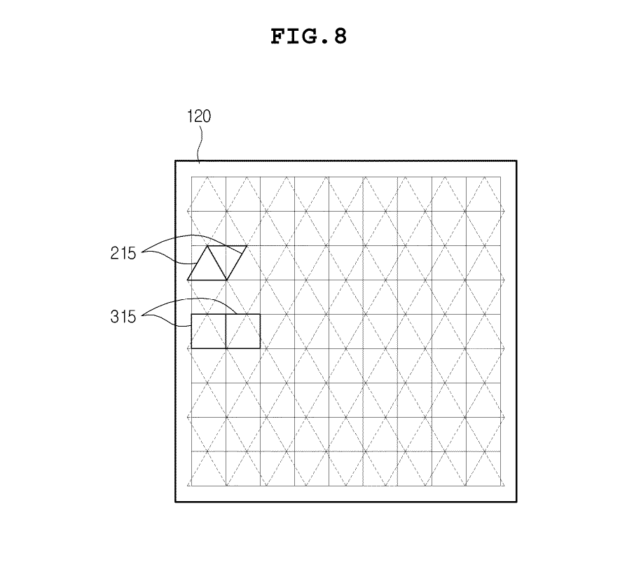

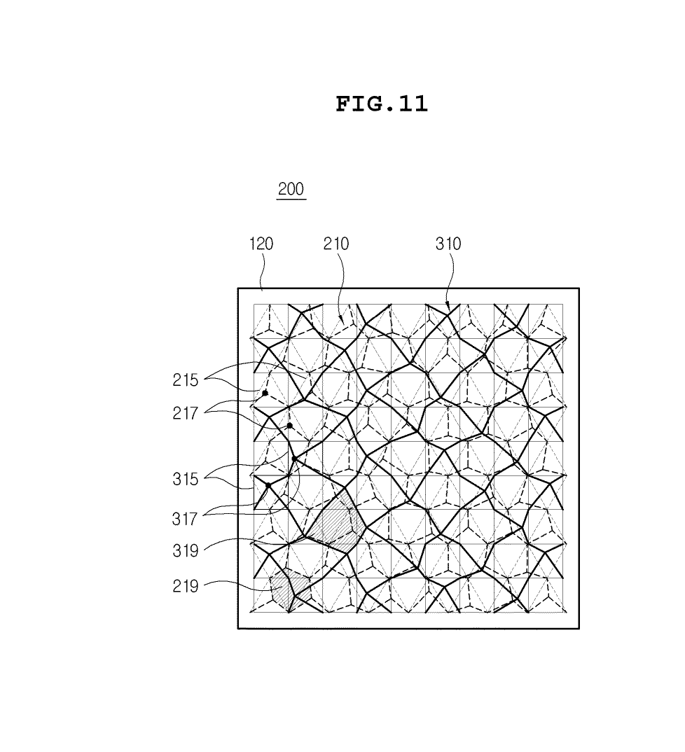

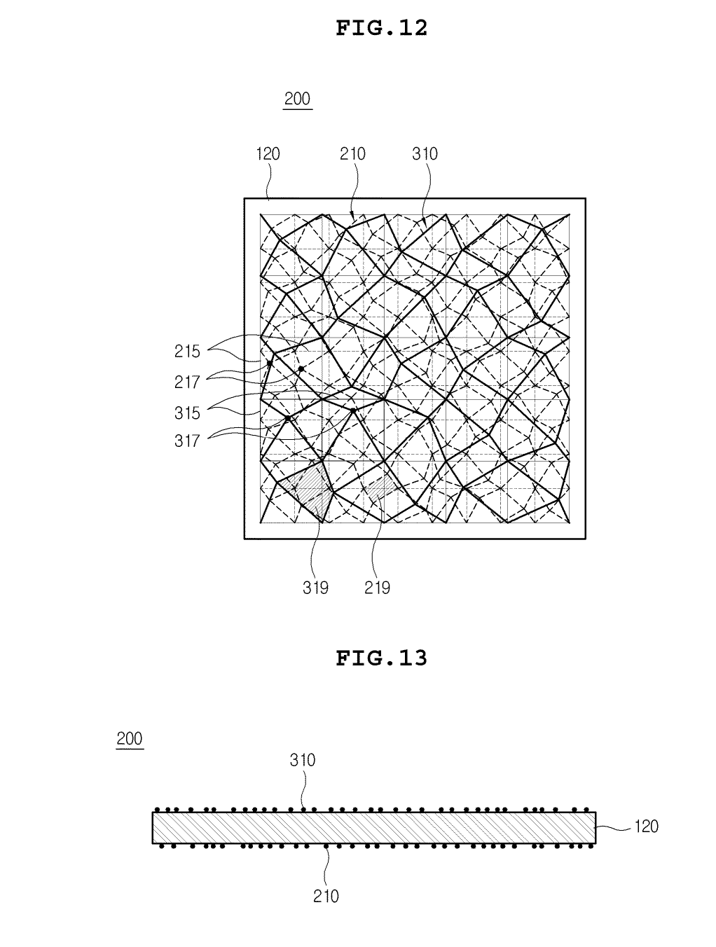

FIGS. 8 to 10 are plan views showing a process of forming an electrode pattern of a touch panel according to another preferred embodiment of the present invention; and FIGS. 11 and 12 are plan views showing a modified example of the touch panel according to another preferred embodiment of the present invention.

As shown in FIGS. 8 to 10, a touch panel 200 according to another embodiment of the present invention includes: a first electrode pattern 210 formed by forming imaginary lattices configured of first polygons 215 which are the same as each other, randomly generating first predetermined points 217 in the first polygons 215, and connecting the first predetermined points 217 and vertexes of the first polygons 215 to each other; and a second electrode pattern 310 formed by forming an imaginary lattice configured of second polygons 315 which are the same as each other, randomly generating second predetermined points 317 in the second polygons 315, and connecting the second predetermined points 317 and vertexes of the second polygons 315 to each other.

The touch panel 200 according to another preferred embodiment of the present invention is different from the touch panel 100 according to the preferred embodiment of the present invention in that the touch panel 200 includes two electrode patterns (a first electrode pattern 210 and a second electrode pattern 310). Therefore, descriptions of the touch panel 200 according to another preferred embodiment of the present invention overlapped with those of the touch panel 100 according to the preferred embodiment of the present invention will be omitted, and will be described based on the first electrode pattern 210, the second electrode pattern 310, or the like.

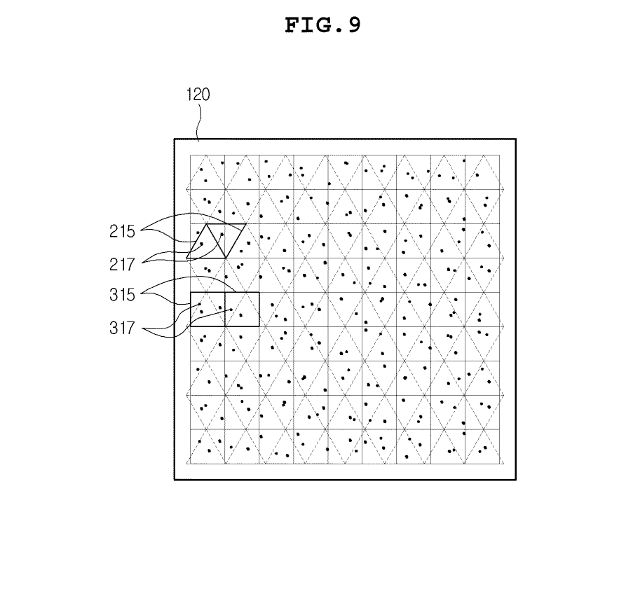

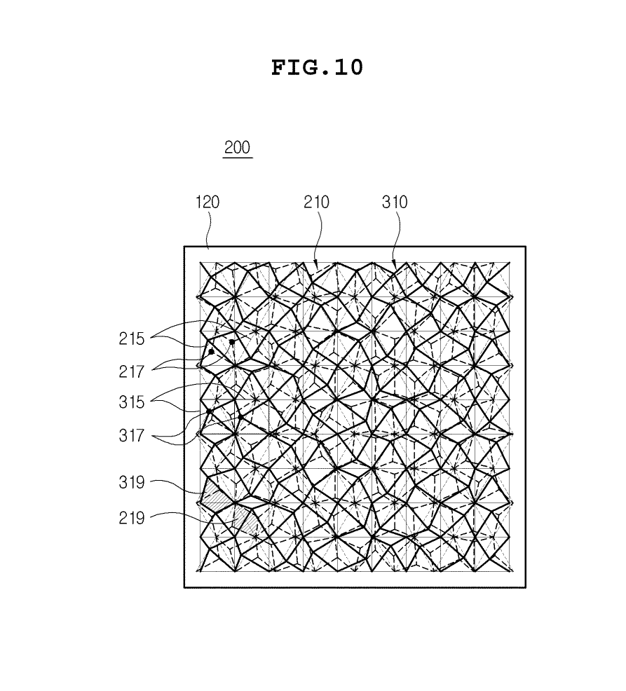

The first and second electrode patterns 210 and 310 in FIG. 10 are patterned according to a regular rule. Firstly, as shown in FIG. 8, the imaginary lattices configured of the first polygons 215 are formed, and the imaginary lattices configured of the second polygons 315 are formed. Here, the first polygons 215 configuring the imaginary lattices are the same as each other and the second polygons 315 configuring the other imaginary lattices are also the same as each other. The first polygons 215 and the second polygons 315 configuring the imaginary lattices, which are bases for generating the first predetermined points 217 and second predetermined points 317, respectively, randomly generate the first predetermined points 217 in the first polygons 215, and randomly generate the second predetermined points 317 in the second polygons 315, as shown in FIG. 9. That is, the first predetermined point 217 may be generated anywhere in the first polygon 215, and the second predetermined point 317 may be generated anywhere in the second polygon 315. After generating the first predetermined points 217 and the second predetermined points 317, as shown in FIG. 10, the first predetermined points 217 are connected to vertexes of the first polygons 215 configuring the imaginary lattices to thereby form the first electrode pattern 210, and the second predetermined points 317 are connected to vertexes of the second polygons 315 configuring the imaginary lattices to thereby form the second electrode pattern 310. Since the first predetermined points 217 and the second predetermined points 317 are randomly formed in the first polygons 215 and the second polygons 315, respectively, the first electrode pattern 210 formed by connecting the first predetermined points 217 and the vertexes of the first polygons 215 to each other and the second electrode pattern 310 formed by connecting the second predetermined points 317 and the vertexes of the second polygons 315 to each other are also irregularly formed. Therefore, each segment of the first and second unit patterns 219 and 319 configuring the first and second electrode patterns 210 and 310 have a random angle and a length of the segment is short. As described above, since the angle of each segment of the first and second unit patterns 219 and 319 configuring the first and second electrode patterns 210 and 310 are random, and the length of the segment is short, period characteristics between the first and second electrode patterns 210 and 310 and a black matrix pattern of a color filter provided in a display are not overlapped with each other, thereby making it possible to prevent the Moire phenomenon and improve visibility. In addition, the first and second predetermined points 217 and 317 are randomly formed in the first and second polygons 215 and 315 to irregularly form the first and second electrode patterns 210 and 310; however, positions at which the first and second predetermined points 217 and 317 are generated are limited in the first and second polygons 215 and 315 configuring the imaginary lattices. Therefore, electrical characteristics and optical characteristics of the first and second electrode patterns 210 and 310 are regular on average, and aperture ratios of the first and second electrode patterns 210 and 310 are also regular on average. In addition, in the case of continuously connecting the first and second unit patterns 219 and 319 of the first and second electrode patterns 210 and 310, the first and second electrode patterns 210 and 310 having a large size may be formed without discontinuity of the electrical characteristics and the optical characteristics.

Meanwhile, the first polygon 215 or the second polygon 315 configuring the imaginary lattices may be a triangle, a quadrangle (FIG. 10), or a hexagon (FIG. 5), respectively.

In addition, as shown in FIG. 11, the first and second predetermined points 217 and 317 are not necessarily formed in all of the first and second polygons 215 and 315 configuring the imaginary lattice, but may be formed at only one polygon of which two polygons are adjacent to each other, which are the first and second polygons 215 and 315. That is, the first and second polygons 215 and 315 having the first and second predetermined points 217 and 317 formed therein and the first and second polygons 215 and 315 not having the first and second predetermined points 217 and 317 formed therein may be alternately present toward one direction according to the imaginary lattices. Here, the first and second unit patterns 219 and 319 configuring the first and second electrode patterns 210 and 310 are the same as combining a plurality of first and second unit patterns 219 and 319 at the time of forming the first and second predetermined points 217 and 317 in the first and second polygons 215 and 315. In addition, since the number of the vertexes of the first and second unit patterns 219 and 319 is increased as compared to the case of forming the first and second predetermined points 217 and 317 in the first and second polygons 215 and 315, each segment of the first and second unit patterns 219 and 319 may have more random angles. Therefore, the touch panel 200 may effectively prevent the Moire phenomenon and improve visibility. Meanwhile, both the first predetermined point 217 and the second predetermined point 317 are formed in only one polygon of which two polygons are adjacent to each other, which are the first and second polygons 215 and 315, in the figures. However, the present invention is not limited thereto, but any one of the first predetermined point 217 and the second predetermined point 317 may be formed in only one polygon of which two polygons are adjacent to each other, which are the first and second polygons 215 and 315.

In addition, the first polygon 215 and the second polygon 315 configuring the imaginary lattices may be the same as each other for convenience of the patterning; however, the first polygon 215 and the second polygon 315 may be different. For example, as shown in FIG. 12, the first polygon 215 and the second polygon 315 may have different size from each other. In the case in which the first polygon 215 and the second polygon 315 are different, the first unit pattern 219 of the first electrode pattern 210 and the second unit pattern 319 of the second electrode pattern 310 to be finally formed are also different. Therefore, since a possibility that period characteristics between the first and second electrode patterns 210 and 310 and a black matrix pattern of a color filter provided in a display are overlapped with each other is more decreased, the Moire phenomenon may be effectively prevented.

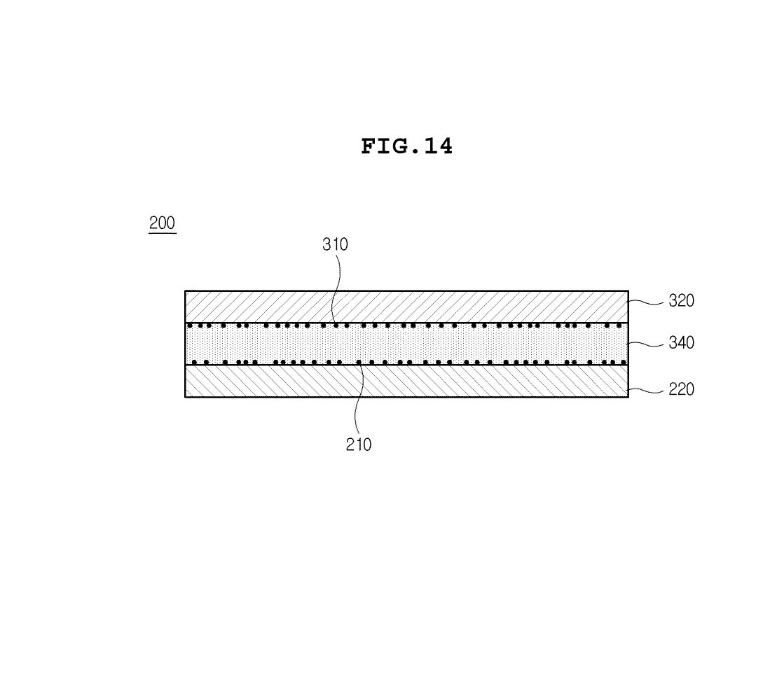

In addition, FIGS. 13 and 14 are cross-sectional views of the touch panel according to another preferred embodiment of the present invention. As shown in FIG. 13, the touch panel 200 according to the present embodiment may include a transparent substrate 120 having the first electrode pattern 210 formed on one surface and the second electrode pattern 310 formed on the other surface. Here, the transparent substrate 120 provides an area at which the first and second electrode patterns 210 and 310, and the electrode wiring will be formed. Meanwhile, the first electrode pattern 210 and the second electrode pattern 310 are not necessarily formed on both surfaces of one transparent substrate 120, respectively. That is, as shown in FIG. 14, two transparent substrates (first transparent substrate 220 and second transparent substrate 320) are provided, the first electrode pattern 210 may be formed on the first transparent substrate 220, and the second electrode pattern 310 may be formed on the second transparent substrate 320. In this case, the first transparent substrate 220 and the second transparent substrate 320 may be adhered by an adhesive layer 340.

In addition, an electrode wiring transmitting/receiving an electrical signal from the first and second electrode patterns 210 and 310 may be formed at edges of the first and second electrode patterns 210 and 310. Here, the electrode wiring may be integrally formed with the first electrode pattern 210 and the second electrode pattern 310 to simplify a manufacturing process and reduce a lead time. In addition, since the electrode wiring and the first and second electrode patterns 210 and 310 are integrally formed, a bonding process of the electrode wiring and the first and second electrode patterns 210 and 310 may be omitted. Therefore, it is possible to previously prevent steps or bonding defects between the electrode wiring and the first and second electrode patterns 210 and 310.

As set forth above, with the touch panel according to the preferred embodiment of the present invention, the imaginary lattices configured of the same polygons as each other is formed, the predetermined points in the polygons are randomly generated, and the predetermined points and the vertexes of the polygons are connected to each other, such that the electrode pattern is irregularly formed, thereby making it possible to prevent the Moire phenomenon and improve the visibility.

In addition, with the touch panel according to the preferred embodiment of the present invention, the predetermined points are randomly formed in the polygons to irregularly form the electrode pattern; however, a position at which the predetermined points are generated in the polygons are limited in the polygons configuring the imaginary lattices. Therefore, electrical characteristics and optical characteristics of the electrode pattern are regular on average, and an aperture ratio of the electrode pattern is also regular on average.

Further, with the touch panel according to the preferred embodiment of the present invention, unit patterns of the electrode patterns are continuously connected to each other, such that the electrode patterns having a large size may be formed without discontinuity of the electrical characteristics and the optical characteristics.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel comprising an electrode pattern formed by forming imaginary lattices configured of same polygons as each other, randomly generating predetermined points in the polygons, and connecting the predetermined points and vertexes of the polygons to each other.

2. The touch panel as set forth in claim 1, wherein the polygon is a triangle, a quadrangle, or a hexagon.

3. The touch panel as set forth in claim 1, wherein the predetermined point is generated at only one polygon of which two polygons are adjacent to each other.

4. The touch panel as set forth in claim 1, further comprising a transparent substrate having the electrode pattern formed thereon.

5. The touch panel as set forth in claim 1, wherein the electrode pattern is made of copper (Cu), aluminum (Al), gold (Au), silver (Ag), titanium (Ti), palladium (Pd), chromium (Cr), or a combination thereof.

6. The touch panel as set forth in claim 1, wherein the electrode pattern is made of metal silver formed by exposing/developing a silver salt emulsion layer.

7. A touch panel comprising:
a first electrode pattern formed by forming imaginary lattices configured of first polygons which are the same as each other, randomly generating first predetermined points in the first polygons, and connecting the first predetermined points and vertexes of the first polygons to each other; and
a second electrode pattern formed by forming imaginary lattices configured of second polygons which are the same as each other, randomly generating second predetermined points in the second polygons, and connecting the second predetermined points and vertexes of the second polygons to each other.

8. The touch panel as set forth in claim 7, wherein the first polygon is a triangle, a quadrangle, or a hexagon, and the second polygon is a triangle, a quadrangle, or a hexagon.

9. The touch panel as set forth in claim 7, wherein the first predetermined point is generated at only one polygon of which two polygons are adjacent to each other.

10. The touch panel as set forth in claim 7, wherein the second predetermined point is generated at only one polygon of which two polygons are adjacent to each other.

11. The touch panel as set forth in claim 7, further comprising a transparent substrate having the first electrode pattern formed on one surface thereof and the second electrode pattern formed on the other surface thereof.

12. The touch panel as set forth in claim 7, further comprising:
a first transparent substrate having the first electrode pattern formed thereon; and
a second transparent substrate having the second electrode pattern formed thereon.

13. The touch panel as set forth in claim 7, wherein the first electrode pattern or the second electrode pattern is made of copper (Cu), aluminum (Al), gold (Au), silver (Ag), titanium (Ti), palladium (Pd), chromium (Cr), or a combination thereof.

14. The touch panel as set forth in claim 7, wherein the first electrode pattern or the second electrode pattern is made of metal silver formed by exposing/developing a silver salt emulsion layer.

15. The touch panel as set forth in claim 7, wherein the first polygon and the second polygon are the same as each other.

16. The touch panel as set forth in claim 7, wherein the first polygon is different from the second polygon.
